(19) United States
(12) Patent Application Publication
(10) Pub. No.: US 2024/0054631 A1
(43) Pub. Date: Feb. 15, 2024

(54) METHOD FOR PROCESSING VOLUME IMAGES BY PRINCIPAL COMPONENT ANALYSIS

(71) Applicants: SAFRAN, Paris (FR); SAFRAN AIRCRAFT ENGINES, Paris (FR); ECOLE NORMALE SUPERIEURE PARIS- SACLAY, Gif-Sur-Yvette (FR); CENTRE NATIONAL DE LA RECHERCHE SCIENTIFIQUE, Paris (FR)

(72) Inventors: Julien Paul SCHNEIDER-DIE-GROSS, Moissy-Cramayel (FR); Clément JAILIN, Gif-Sur-Yvette (FR); Arturo MENDOZA QUISPE, Moissy-Cramayel (FR); Stéphane ROUX, Paris (FR)

(73) Assignees: SAFRAN, Paris (FR); SAFRAN AIRCRAFT ENGINES, Paris (FR); ECOLE NORMALE SUPERIEURE PARIS- SACLAY, Gif-Sur-Yvette (FR); CENTRE NATIONAL DE LA RECHERCHE SCIENTIFIQUE, Paris (FR)

(21) Appl. No.: 18/259,488

(22) PCT Filed: Dec. 24, 2021
(86) PCT No.: PCT/FR2021/052452

§ 371 Date: Jun. 27, 2023

(30) Foreign Application Priority Data
Dec. 30, 2020 (FR) FR2014274

(51) Int. Cl. G06T 7/00; G06T 7/60; G06T 15/00

(52) U.S. Cl. CPC G06T 7/0008; G06T 7/60; G06T 15/00; G06T 2207/10081; G06T 2207/30164

(57) ABSTRACT

Method for processing a plurality of X-ray tomography volume images each associated with a part, the plurality of volume images comprising a reference volume image, including:
a step of correlating volume images to obtain a displacement field between each image and the reference image, to obtain a plurality of displacement fields minimizing the difference between the volume images,
a processing by a dimensionality reduction method of the plurality of the image displacement fields to express them according to eigenmodes, and
a statistical analysis of the fields expressed according to the eigenmodes.

### CROSS-REFERENCE TO RELATED APPLICATIONS

This is a National Stage Application under 35 U.S.C. § 371 of International Application No. PCT/FR2021/052452, filed Dec. 24, 2021, now published as WO 2022/144523 A1, which claims priority to French Patent Application No. 2014274, filed on Dec. 30, 2020.

### TECHNICAL FIELD

The invention falls within the field of the design, characterization and monitoring of parts for industry, in particular parts that have to undergo significant mechanical stresses such as, for example, parts of aircraft engines. The invention particularly relates to the dispersions that appear in a series of parts.

### PRIOR ART

In the prior art, the manufacture of the blades (“fan blades”) of aircraft turbomachines is a particularly critical method. These blades are generally made of woven material embedded in a resin matrix. The weaving can be a 2D or 3D weaving.

The woven structure therefore appears as a structure that must have an expected shape but which may however present microstructure variabilities (such as for example a spacing between strands). It is generally desired to minimize these microstructure variabilities. For a series of parts, reference can also be made to statistical dispersions of the mechanical properties and these dispersions are to be quantified.

By dispersion or by statistical dispersion, it is meant any variability of a characteristic (size, shape, constitution, microstructure, etc.) that may appear between different parts from the same manufacturing line. This dispersion may or may not be acceptable, depending on the specifications established beforehand.

In the composite technologies using a fibrous reinforcement in the form of (2D and 3D) weaving, it is known that the dispersion in terms of mechanical characteristics is essentially introduced by the dispersion called geometric dispersion of the textile reinforcement, once woven then injected/impregnated. The geometric dispersion is a dispersion that targets geometric variability, for example the shape, positioning, etc.

It is particularly difficult to know the link between the geometric dispersion and the dispersion on the mechanical properties. Tests on planar plates with different composite structures are usually carried out to quantify the dispersions on the mechanical properties (stiffnesses, ultimate strengths, endurance limit, Wohler curves, etc.) to then take them into account on the final product (part). These tests are particularly expensive.

It can be noted that there are observable dispersions at the level of the materials (for example a woven plate) and observable dispersions at the level of the finished parts.

From the state of the prior art, document FR 13 63095 is known which describes a method using X-ray tomography (CT for Computed Tomography). This experimental means uses the differential absorption of the X-rays by different materials to reconstruct, by calculation, from a series of x-rays, a three-dimensional image of the studied part. The information contained in the tomography images is valuable because it concerns the entire volume of the part and gives access not only to its microstructure but also potentially to its defects.

In this previous document, a Volume Image Correlation (VIC) applied to X-ray tomography images is implemented. The solution proposed in this document makes it possible to measure a geometric difference between two samples.

From the state of the prior art, document “Stochastic analysis and validation under aleatory and epistemic uncertainties” is also known (MCKEAND AUSTIN M ET AL, RELIABILITY ENGINEERING AND SYSTEM SAFETY, ELSEVIER APPLIED SCIENCE, GB, vol. 205, 2 Oct. 2020, XP32539873, ISSN: 0951-8320, DOI: 10.1016/J.RESS.2020.107258) which describes the inspection of turbomachine components from X-ray tomography images.

Finally, document “PCA-based Adaptative Hierarchical Transform for correlated image groups” is known (KOUNTCHEV ROUMEN ET AL, 2013 11TH INTERNATIONAL CONFERENCE ON TELECOMMUNICATIONS IN MODERN SATELLITE, CABLE AND BROADCASTING SERVICES (TELSIKS), IEEE, vol. 1, 16 Oct. 2013, pages 323-332, XP32539873, DOI: 10.1109/TELSKS. 2013.6704941, ISBN: 978-1-4799-0899-8) describes a principal component analysis method.

The correlation of volume images applied to only two images does not make it possible to illustrate the dispersions mentioned above for a set of parts. The invention aims in particular to overcome this drawback.

### DISCLOSURE OF THE INVENTION

To this end, the invention proposes a method for processing a plurality of X-ray tomography volume images each associated with a part (for example a part of a series of parts; for example, each part of the series of parts is associated with a volume image of the plurality of volume images), to quantify the geometric dispersion between parts, the plurality of volume images comprising a reference volume image, including:
a step of correlating volume images to obtain a displacement field between each image and the reference image, to obtain a plurality of displacement fields minimizing the difference between the volume images (in other words, the application of the displacement field allows having volume images that match as much as possible),
a processing by a dimensionality reduction method of the plurality of the displacement fields to express them according to the eigenmodes,
a statistical analysis of the fields expressed according to the eigenmodes.

The method can be applied to X-ray tomography volume images each associated with different parts.

The study of the dispersions or statistical dispersions from the sole geometry of the parts or volume images is too complex to implement useful statistical analyses. It has been observed that from the study of the displacement fields which makes the volume images match, with first of all a reduction of the dimensionality, it is possible to easily deduce and in an effective way statistical information by the statistical analysis.

In fact, the space of the eigenmodes which are defined by the method of reduction of the dimensionality is a good space to represent the geometric variations which are most frequent and thus to make appear the outliers that may appear on some parts.

The methods known under the name of “dimensionality reduction methods” are aimed here, and more particularly the methods known as “spectral” methods. These methods generally comprise two steps (i) the construction of a matrix and (ii) the extraction of the eigenmodes of this matrix.

The best-known method of this type is the Principal Component Analysis (PCA). Other methods are known such as those called “Kernel Principal Component Analysis” (“Non-linear Component Analysis as a Kernel Eigenvalue Problem”, Scholkopf et al., Neural Computation, vol. 10, no. 5, pp. 1299-1319,1998), “Isomap” (“A global geometric framework for non-linear dimensionality reduction”, Tenenbaum et al., Science, 290:2319-2323, December 2000), “Locally Linear Embedding” (“Non-linear dimensionality reduction by locally linear embedding”, Saul & Roweis, Science, v. 290 no. 5500, Dec. 22, 2000. pp. 2323-2326), “Laplacian Eigenmaps” (“Laplacian Eigenmaps for Dimensionality Reduction and Data Representation” Belkin & Niyogi, Neural Computation 15, 1373-1396 (2003)), and “Maximum Variance Unfolding” (MVU, Weinberger and Saul, Kilian Q. and Lawrence K. (27 Jun. 2004b). Unsupervised learning of image manifolds by semidefinite programming. 2004 IEEE Computer Society Conference on Computer Vision and Pattern Recognition. 2.). It can be noted that some of these methods are non-linear while the principal component analysis is linear, and that some of these methods can use other elements to build said matrix.

Furthermore, some of these methods can be seen as several PCAs (or Kernel-PCAs) made locally and combined globally according to different strategies.

It can be noted that here, the matrix in question is constructed by combining the displacement fields weighted by the uncertainty matrix.

Therefore, it will be easier to identify a defective part, for example if the chosen statistical analysis illustrates that this part has a mode expressed in such a way that it may correspond to a defect.

The statistical analysis can for example be a method for detecting outliers.

According to one particular mode of implementation, the statistical analysis of the fields expressed according to the eigenmodes is a graphical analysis, by means of a graphical display.

For example, it is possible to observe the distribution of the parts for each mode, for example by a histogram. It is also possible to represent for each part an intensity value associated with each mode to determine if a part is abnormal.

According to one particular mode of implementation, the dimensionality reduction method is a “principal component analysis” (PCA).

It has been observed by the inventors of the present invention that the principal component analysis is particularly effective in determining eigenmodes for the displacement fields which are chosen to minimize the difference with the reference image.

In fact, the space of the eigenmodes of the PCA is a good space to represent the differences between the displacement fields. With the amplitudes of the displacement field projected on the eigenmodes, it is possible to easily check whether a part is too far from the reference part. This makes it possible in particular to rule out as defective a part that is too far from it.

The principal component analysis has the advantage of delivering linear combinations according to the modes, which makes it possible in particular to observe the influence of a mode (for example by removing its contribution).

According to one particular mode of implementation, the plurality of images contains N images each associated with a displacement field \vec{u}(\vec{x},n) with n∈[1, N], and in which the processing by principal component analysis makes it possible to express a displacement field according to the formula:

\vec{u}(\vec{x},n)=Σⱼ^{p}\vec{s}ⱼ(\vec{x})σⱼβⱼₙ
with \vec{s}ⱼ(\vec{x}) an eigenmode (left eigenmode),
σⱼ the eigenvalues,
βⱼₙ the associated right eigenmode (with the left mode), and
p the minimum between the number of degrees of freedom of \vec{u}(\vec{x},n) and N. For example, \vec{x} denotes a position and n denotes an integer comprised between 1 and N.

For example, p can be equal to N, but it is possible to choose p with a value less than N to limit the number of processed modes.

As seen in the formula above, there is indeed a linear combination of modes, which makes it easy to identify what each mode on the parts corresponds to.

According to one particular mode of implementation, the dimensionality reduction method on a plurality of transformed displacement fields is implemented by the formula:

Vᵢⱼ=Cᵢₖ^{-1/2}Uₖⱼ

with Cᵢₖ^{-1/2} the covariance matrix of the plurality of displacement fields Uₖⱼ.

For example with i, j, and k integer indices.

This particular mode of implementation makes it possible to implement a weighting of the displacement fields by a measurement of the uncertainty (which makes it possible to obtain Cᵢₖ^{-1/2}), which then makes it possible to implement a principal component analysis that takes into account this uncertainty.

According one a particular mode of implementation, the processing by principal component analysis makes it possible to express a displacement field \vec{u}(\vec{x},n) according to the formula:

\vec{u}(\vec{x},n)=Σⱼₖ^{p}Cᵢₖ^{1/2}αₖⱼ\vec{φ}ᵢ(\vec{x})σⱼβⱼₙ

with Cᵢₖ^{1/2} the covariance matrix of the plurality of displacement fields, \vec{φ}ᵢ(\vec{x}) a basis of shape functions from the method of the finite elements, σⱼ the eigenvalues, αₖⱼ a left eigenmode, and βⱼₙ the associated right eigenmode (on the left).

For example, \vec{x} denotes a position and n denotes an integer comprised between 1 and N.

For example, i, j, and k are integer indices. p can be equal to N, but it is possible to choose p with a value less than N to limit the number of processed modes.

For example, there is a database U consisting of n achievements (j=1, . . . , n) of displacement fields Uᵢⱼ each having q degrees of freedom (i=1, . . . , q). This particular mode of implementation is an alternative to the definition presented above for \vec{u}(\vec{x},n). This formulation is advantageous but requires developing the covariance matrix.

According to one particular mode of implementation, the method further includes a determination of an average image ĝ(\vec{x}):

$$\hat{g} ( \vec{x} ) = ( \frac{1}{N} ) {\sum }_{n = 1}^{N} \tilde{g} ( \vec{x} , n )$$

with N the number of images and \tilde{g}(\vec{x},n) the images obtained after application of the displacement field \vec{u}(\vec{x}):

\tilde{g}(\vec{x})=g(\vec{x}+\vec{u}(\vec{x})).

This average image is a good statistical representation of a part that represents the plurality of parts.

In this particular mode of implementation, an average part is obtained by the displacement fields which have been determined. This is less complex than a determination of an average part from the volume images alone.

According to one particular mode of implementation, in which one of the characteristics of production of the parts may vary, the method further includes a determination of one or more modes affected by that characteristic, and a determination of the influence of the characteristic on the geometry of the parts.

For example, for a woven part, it is known that some parameters of the looms have an effect on the geometry of the textile. However, it is very difficult to determine or classify these parameters having significant influence. This difficulty results from the strong couplings between the parameters (molding and tension of the strands for the woven parts, for example).

In the methods according to the prior art, the identification of these parameters involved the production of a panel large enough to then allow the machining of the material test specimens in order to then be able to carry out mechanical tests.

By material test specimens, it is meant a sample large enough to be representative of the material to be studied. In fact, the test specimens are generally designed to study a specific phenomenon of the material (for example the fatigue behavior).

When a plurality of parts or samples is made with different methods, or different parameter values characterizing this method, then the characterization of the displacement amplitudes relative to the reference part according to the modes of the PCA, makes it possible to determine whether this method variant, or whether this parameter, has a significant influence.

The proposed invention can also be applied during a method for manufacturing a part from the method for processing a plurality of volume images as defined above.

Particularly, this method is suitable if production characteristics are identified as having an impact (visible on one or more modes), and if these characteristics are changed during the manufacturing method.

As an indication, the characteristic may be a characteristic of installation of a woven part. For example, a mode or several modes associated with a translation displacement can illustrate this characteristic.

The characteristic may relate to the shaping of the reinforcements. For example, one or several mode(s) associated with distortions or elongations can illustrate these characteristics.

The invention also proposes a method for monitoring a line of manufacture of parts comprising an acquisition of X-ray tomography volume images of the parts and an implementation of the processing method as defined above.

In this method, it is further possible to discard a part that appears to be too far from the other parts according to the principal component analysis.

According to one mode of implementation applicable to all the methods as defined above, the parts comprise a composite material (for example with weaving, lamination and braiding, etc.).

According to one particular mode of implementation, the part is in a state in which no injection of resin has been implemented (for example woven and without resin).

It has been observed that a reduction of the dimensionality followed by a statistical analysis makes it possible to obtain results on composite parts, for example woven parts, before their injection because the geometry of the textile can already be studied after the weaving, for example. In fact, the woven part without injection is a preform placed in a mold, and the absence of resin makes it easier to obtain images because the contrast (strand/air) is better than in the presence of resin.

According to one particular mode of implementation applicable to all the methods as described above, the part is an aircraft turbomachine blade.

The invention also proposes a system for processing a plurality of X-ray tomography volume images each associated with a part, to quantify the geometric dispersion between parts, the plurality of volume images comprising a reference volume image, the system including:
a volume image correlation module to obtain a displacement field between each image and the reference image, to obtain a plurality of displacement fields minimizing the difference between the volume images (in other words, the application of the displacement field makes it possible to have volume images that match as much as possible),
a processing module by a dimensionality reduction method of the plurality of the displacement fields to express them according to eigenmodes,
a statistical analysis module of the fields expressed according to the eigenmodes.

This system can be configured for the implementation of all the modes of implementation of the methods as described above. Furthermore, this system can be a computer system (for example a computer).

The invention also proposes a computer program including instructions for the execution of the steps of a processing method as defined above when said program is executed by a computer.

It is noted that the computer programs mentioned in the present disclosure can use any programming language, and be in the form of source code, object code or intermediate code between source code and object code, such as in a partially compiled form, or in any other desirable form.

The invention also proposes a recording medium readable by a computer on which a computer program is recorded comprising instructions for the execution of the steps of an image security method as defined above.

The invention also proposes a recording medium readable by a computer on which a computer program is recorded comprising instructions for the execution of the steps of a processing method as defined above.

The recording (or information) media mentioned in the present disclosure can be any entity or device capable of storing the program. For example, the medium can include a storage medium, such as a ROM, for example a CD ROM or a microelectronic circuit ROM, or a magnetic recording means, for example a floppy disk or a hard disk.

On the other hand, the recording media can correspond to a transmissible medium such as an electrical or optical signal, which can be conveyed via an electrical or optical cable, by radio or by other means. The program according to the invention can be particularly downloaded from an Internet-type network.

Alternatively, the recording media can correspond to an integrated circuit in which the program is incorporated, the circuit being adapted to execute or to be used in the execution of the method in question.

### BRIEF DESCRIPTION OF THE DRAWINGS

Other characteristics and advantages of the present invention will become apparent from the description given below, with reference to the appended drawings which illustrate an exemplary embodiment devoid of any limitation. In the figures:

FIG. 1 is a schematic representation of a method according to one example.

FIG. 2 is a schematic representation of a system according to one example.

### DESCRIPTION OF THE EMBODIMENTS

A method for processing X-ray tomography volume images each associated with a part will now be described.

In what follows, the parts are woven parts, typically aircraft turbomachine blades.

The invention is however not limited to these parts and can be applied to any composite woven part, whose tomographic images can be followed by correlation of volume images. The method can be applied to a woven composite part or to a laminated composite part (two woven composites) insofar as the resolution makes it possible to differentiate the layers of unidirectional laminates.

The method described here makes it possible to quantify the geometric dispersion between parts, and it makes it possible in particular to determine whether a part is acceptable or not (for example by using given thresholds).

This method can therefore be used in a production line monitoring method, in a design method, or in a part manufacturing method.

It can be noted that the inventors of the present invention obtained volume images for a set of 64 aircraft turbomachine fan blades which were observed by micro-tomography. Among this set of blades, one is chosen as a reference (the first in the list, for example). The other blades are considered as the test blades (i.e., deformed). As would be described in more detail below, the VIC can be applied to the 63 pairs of images (each of the common parts with the reference) by using the same kinematic decomposition to obtain displacement fields. This decomposition is based on an unstructured FE mesh formed by tetrahedral elements. Similarly, the gray level correction is performed on a mesh formed by tetrahedral elements.

The displacement fields obtained are not very usable because they are too complex, particularly if one part is wished to be studied in relation to the others.

It is therefore proposed to implement a dimensionality reduction method to express the displacement fields according to a reduced number of well-chosen modes (the first modes, those with the largest eigenvalues). The principal component analysis is well suited for expressing the fields according to modes that illustrate the distributions in a series of parts, but other methods can be used.

This makes it possible in particular to implement a graphical analysis where the intensity of each mode retained by the principal component analysis is expressed with colors.

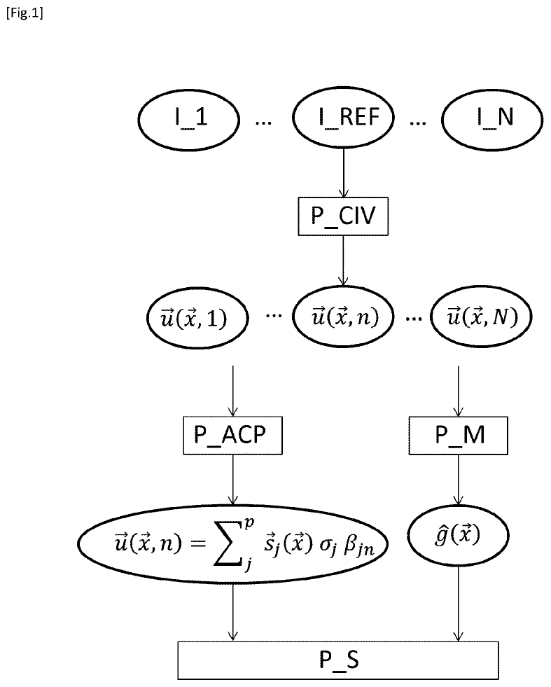

In the method of FIG. 1, N X-ray tomography volume images are used as input, each associated with a part and denoted I_1 to I_N. A reference volume image I_ref comprised in the plurality of images is also used.

In a first step of the method P_VIC, a volume image correlation (VIC) is implemented, for example according to the method described in the prior document FR 13 63095. As explained above, it is for example possible to use 64 volume images of fan blades or other parts.

The VIC consists of measuring the (volume) displacement fields between pairs of (volume) images. It is based on the principle of conservation of gray levels, which is written:

f(\vec{x})=g(\vec{x}+\vec{u}(\vec{x}))

with f(\vec{x}) the reference image I_ref, a test image I_testg(\vec{x}) (also called distorted test image) and a displacement (vector) field \vec{u}(\vec{x}) which is decomposed on a basis of shape functions \vec{ϕ}(\vec{x}) from the method of the finite elements (EF):

\vec{u}(\vec{x})=Σuᵢ\vec{ϕ}ᵢ(\vec{x})

In fact, a blade image is chosen as a reference image and the 63 others are test images (i.e. distorted).

Thus, it is possible to calculate the corrected distorted image I_cor:

\tilde{g}(\vec{x})=g(\vec{x}+\vec{u}(\vec{x}))

The residual field can also be calculated as follows:

ρ(\vec{x})=\tilde{g}(\vec{x})−f(\vec{x})

Thus, the optimal displacement field is the one that minimizes the norm L₂ of the residuals ρ(\vec{x}) in the region of interest (ROI).

It is important to note the Lagrangian nature of the displacement field, in the sense that the displacement field is expressed in the reference frame of the reference image.

This new image is expressed in the same space (reference frame) as the reference image.

In addition, this formulation can be modified in order to take into account the variations in the gray levels extrinsic to the displacement such as tomographic reconstruction artifacts (artifact known as “cupping” due to the hardening of the beam, or the diffusion effect). Thus, the extended formulation is written:

f(\vec{x})=g(\vec{x}+\vec{u}(\vec{x}))·a(\vec{x})+b(\vec{x})

With the (scalar) fields that contribute to the contrast changes a(\vec{x}) and to the brightness changes b(\vec{x}). These fields are themselves projected on a reduced basis with shape functions ψ(\vec{x}) resulting from the method of the finite elements:

a(\vec{x})=Σaᵢψᵢ(\vec{x})

and

b(\vec{x})=Σbᵢψᵢ(\vec{x}).

It will be noted that these fields are not necessarily decomposed on the same basis (mesh EF). Similarly, these fields can then be regularized by specialized techniques (mechanical regularization, regularization by the Laplace operator). Thus, it is possible to distinguish between the effects related to the displacement and the effects related to the gray level change.

Then, the step P_PCA of processing by principal component analysis can be implemented.

The invention is however not limited to the principal component analysis and may involve the implementation of other dimensionality reduction methods.

The statistical analysis proposed here is based on the Principal Component Analysis (PCA). This approach consists of an orthogonal transformation which converts a database U made up of n achievements (j=1, . . . , n) of displacement fields Uᵢⱼ each having q degrees of freedom (i=1, . . . , q), into a set of linearly independent variables. These achievements will be the displacement fields per image. Indeed, the singular value decomposition theorem asserts that there exist two unitary matrices:

A={α₁,α₂, . . . ,α_{q}}

and

B={β₁,β₂, . . . ,βₙ}

so that

U=AΣB^{T}

with

Σ=diag(σ₁,σ₂, . . . ,σₚ)

with p=min(q,n) and σ₁≥σ₂≥ . . . ≥σₚ≥0. The values of the diagonal of the matrix E are the eigenvalues while the columns of the matrices A and B are the left and right eigenvectors (that is to say modes) respectively.

It is possible to generalize the PCA via a weighting by a measure of uncertainty. If C denotes the covariance matrix of the displacement fields constituting the database, then it will be advantageous to introduce the base V consisting of the n transformed displacement fields, Vᵢⱼ=Cᵢₖ^{-1/2} Uₖⱼ. The PCA decomposition of V=AΣB^{T} will then make it possible to return to spatial modes in the form of displacement fields via Sᵢⱼ=Cᵢₖ^{1/2}Aₖⱼ, or \vec{s}ⱼ(\vec{x})=Sᵢⱼ\vec{ϕ}ᵢ(\vec{x}).

In the case of VIC, the inverse of the covariance matrix of the displacement fields is directly proportional to the correlation matrix, C⁻¹∝M. When the calculation of the matrix C^{1/2} is too cumbersome to implement, a simple approximation can be enough by keeping only the diagonal elements of M as an approximation of C⁻¹.

In this case,

$${[ {C}^{1 / 2} ]}_{i j} \approx {m}_{ii}^{- \frac{1}{2}} {δ}_{i j}$$

(it is noted that the implicit sum convention on repeated indices, or Einstein's convention is not followed here). Using the PCA decomposition directly on U can be seen as an even rougher approximation of the covariance matrix then considered proportional to the identity.

For the database of N images g(\vec{x},n) with n∈[1, N] indicating the image in question, and a reference image f(\vec{x}), the VIC will be applied in order to obtain the displacement fields \vec{u}(\vec{x},n) linking each test image of the database to the chosen reference image.

Moreover, this calculation gives access to the N images \tilde{g}(\vec{x},n) representing the database expressed in a single space (reference frame), that of the reference image.

Thus, two analyzes are possible:
on the set of the corrected images \tilde{g}(\vec{x},n) and
on all displacement fields \vec{u}(\vec{x},n).

The first analysis (step P_M in FIG. 1) consists of obtaining the average image of the corrected images:

$$\hat{g} ( \vec{x} ) = ( \frac{1}{N} ) {\sum }_{n = 1}^{N} \tilde{g} ( \vec{x} , n )$$

which represents the “average blade” of the studied database.

The second analysis (step P_PCA) consists in obtaining the eigenmodes describing the kinematics of the database (movement of rigid body excluded). Indeed, thanks to PCA analysis, any displacement field \vec{u}(\vec{x},n) belonging to the database can be described as a linear combination:

\vec{u}(\vec{x},n)=Σⱼₖ^{p}Cᵢₖ^{1/2}αₖⱼ\vec{ϕ}ᵢ(\vec{x})σⱼβⱼₙ=Σⱼ^{p}\vec{s}ⱼ(\vec{x})σⱼβⱼₙ,

with \vec{s}ᵢ the left eigenvector corresponding to the spatial modes, βⱼₙ the right eigenvector containing the amplitude modes according to the indexing of the samples of the base, σᵢ the associated eigenvalue. In this way, the collection of spatial modes provides information on the typology (for example translation, rotation, movements of rigid bodies, dilation, homogeneous deformation, etc.) of the displacements observed in the database incorporating the weighting adapted to the uncertainties of measurement by VIC. Similarly, β provides information on the weight of the spatial modes in the samples of the database.

Lastly, an analysis step P_S of the fields expressed according to the eigenmodes can be implemented.

Thus, there is access to a “clean” statistical analysis of the database, especially since the modes are orthogonal to each other via the scalar product [symbol] a, b [symbol] =a^{T}Mb. It is then possible to characterize, through the spatial modes, the distribution of the kinematics of the blades in the database.

Although several methods exist to characterize a probabilistic distribution, the example of the estimation by Gaussian functions can be cited. If this Gaussian Mixture Model is applied with a single Gaussian, the observed dispersion can be explained by an average (c.f. the average blade) and a variation around this average.

In this way, it is then possible to quantify the statistical dispersion (from a geometric point of view) on the parts tested (which can form the statistical analysis step). The method described here is applicable to the scale of the material as well as to the scale of the parts, provided that the image (tomography here) serving as support for the calculations of the kinematic fields has a sufficiently fine resolution and makes it possible to reveal the critical geometric differences with respect to the dispersion sought to be characterized.

The method described with reference to FIG. 1 can be used to determine the manufacturing characteristics having a significant influence on the geometry of the parts.

For this purpose, parts produced according to any variant of the manufacturing method can be used, the methodology proposed here further comprising a determination of the significant nature of this variant.

It should be noted that, for example, only some characteristics of looms have an effect on the geometry of the textile. Nevertheless it is very difficult to determine them (or to classify them) because of the strong couplings between the characteristics (for example, the spacing of the strands and their tension).

With the method described above, the production of parts with different manufacturing variants makes it easy to identify those that have a significant influence by the PCA. In particular, it twill be possible to determine those whose influence exceeds a given threshold and which lead to unacceptable parts.

It can also be noted that for the woven parts, it is not necessary to perform resin injections if it is the textile geometry that is studied here.

The person skilled in the art will be able to choose the most relevant parameters and regions of the parts to be studied (for example external or internal layers).

The method described above further makes it possible to quantify the geometric dispersion of the N parts.

It should be noted that the PCA here provides a quantification of the “geometric” dispersion, without information on the mechanical properties of the parts.

On the other hand, subject to having a faithful numerical mechanical modeling of a part, then it is easy to modify the geometry of the part as described by the PCA, and to deduce therefrom the effect of a geometric variability on the variability of a mechanical property. The interest of the PCA in this context is to limit the calculations necessary to the modifications of geometry given by the eigenmodes with an amplitude defined by the standard deviation of the distribution of the modal amplitudes.

The method described above also makes it possible to implement a monitoring of a part production line.

For example, by treating each new part and its volume image as an additional image in the plurality of images to be processed, it is possible to update the principal component analysis and verify that the new part is not too geometrically different from the others. This also makes it possible to observe deviations from the production line.

For some woven parts (for example fan blades), the installation of the preform in its mold (overall rigid movement), as well as the local movements carried out by the operator (local deformations) are of first order on the history of the part (in addition to those previously defined on the material level but which are already taken into account in the dimensioning methods). Thus, even with larger scale tomographies, such as those used for serial control, it is possible to follow key indicators on the mechanical potential of the part, and therefore to quantify the dispersion of a given production according to the tomographies considered for the study. These are manufacturing characteristics that can be identified here.

In this way, it is possible to voluntarily choose a part with respect to the measured dispersion (“average” part or “part at the ends of the estimation of the statistical model”) and even to know a posteriori the history of a blade tested for certification tests compared to a production that will arrive later and thus make it possible to generate margins if the blade were an average blade (it is always assumed that the blade used for the test is the worst of the production because it is impossible to position it without the method proposed here, as it is not known which is the worst of the blades, and conservatisms to the tested blade are added in order to be sure that there is not enough margin and that the whole of a production will be covered).

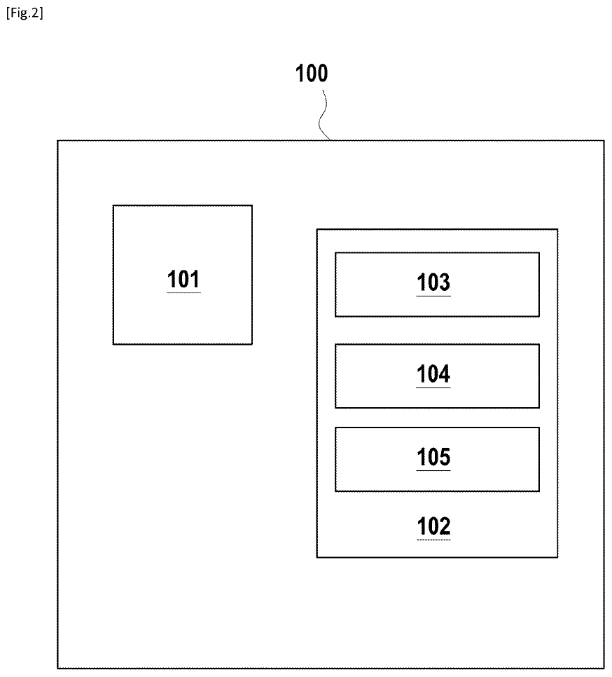

FIG. 2 is a schematic representation of a system 100 capable of implementing the method described with reference to FIG. 1.

This system 100 includes a processor 101 and a non-volatile memory 102 so that it has the structure of a computer system.

In the memory 102, it includes a computer program comprising:
instructions 103 for the implementation of step P_VIC, and therefore forming a volume image correlation module when they are executed by the processor 101, and
instructions 104 for the implementation of the step P_PCA, and therefore forming a principal component analysis module when they are executed by the processor 101, and
instructions 105 for the implementation of the step P_S, and therefore forming a statistical analysis module when they are executed by the processor 101.

1. A method, implemented by a computer system, for processing a plurality of X-ray tomography volume images (I_1, . . . , I_N) each associated with a part, to quantify the geometric dispersion between parts, the plurality of volume images comprising a reference volume image, including:
a step (P_VIC) of correlating volume images to obtain a displacement field between each image and the reference image, to obtain a plurality of displacement fields minimizing the difference between the volume images,
a processing by dimensionality reduction method (P_PCA) of the plurality of the image displacement fields to express them according to eigenmodes,
a statistical analysis of the fields expressed according to the eigenmodes.

2. The method according to claim 1, wherein the statistical analysis of the fields expressed according to the eigenmodes is a graphical analysis, by means of graphical display.

3. The method according to claim 1, wherein the dimensionality reduction method is a principal component analysis.

4. The method according to claim 3, wherein the plurality of images contains N images each associated with a displacement field \vec{u}(\vec{x},n) with n∈[1, N], and wherein the processing by principal component analysis makes it possible to express a displacement field according to the formula:
\vec{u}(\vec{x},n)=Σⱼ^{p}\vec{s}ⱼ(\vec{x})σⱼβⱼₙ
with \vec{s}ⱼ(\vec{x}) an eigenmode,
σⱼ the eigenvalues,
βⱼₙ the associated right eigenmode, and
p the minimum between the number of degrees of freedom of \vec{u}(\vec{x},n) and N.

5. The method according to claim 1, wherein the dimensionality reduction method on a plurality of transformed displacement fields Vᵢⱼ is implemented by the formula:
Vᵢⱼ=Cᵢₖ^{-1/2}Uₖⱼ.
with Cᵢₖ^{-1/2} the covariance matrix of the plurality of displacement fields Uₖⱼ.

6. The method according to claim 3, wherein the processing by principal component analysis makes it possible to express a displacement field \vec{u}(\vec{x},n) with n∈[1,N] according to the formula:
\vec{u}(\vec{x},n)=Σⱼₖ^{p}Cᵢₖ^{1/2}αₖⱼ\vec{ϕ}ᵢ(\vec{x})σⱼβⱼₙ
with Cᵢₖ^{1/2} the covariance matrix of the plurality of displacement fields, \vec{ϕ}ᵢ(\vec{x}) a basis of shape functions from the method of the finite elements, σⱼ the eigenvalues, αₖⱼ an eigenmode, and βⱼₙ the associated right eigenmode.

7. The method according to claim 1, further comprising a determination of an average image ĝ(\vec{x}):
$$\hat{g} ( \vec{x} ) = ( \frac{1}{N} ) {\sum }_{n = 1}^{N} \tilde{g} ( \vec{x} , n )$$
with N the number of images and \tilde{g}(\vec{x},n) the images obtained after application of the displacement field \vec{u}(\vec{x}):
\tilde{g}(\vec{x})=g(\vec{x}+\vec{u}(\vec{x})). i.

8. The method according to claim 1, wherein one of the characteristics of production of the parts may vary, the method further comprising a determination of one or more modes affected by that characteristic, and a determination of the influence of the characteristic on the geometry of the parts.

9. A method for manufacturing a part from the method according to claim 1.

10. A method for monitoring a line of manufacture of parts comprising an acquisition of X-ray tomography volume images of the parts,
an implementation of the processing method according to claim 1 on the acquired X-ray tomography volume images.

11. The method according to claim 1, wherein the parts comprise a composite material.

12. The method according to claim 11, wherein the part is in a state in which no injection of resin has been implemented.

13. The method according to claim 1, wherein the part is an aircraft turbomachine blade.

14. A system for processing a plurality of x-ray tomography volume images each associated with a part, to quantify the geometric dispersion between parts, the plurality of volume images comprising a reference volume image, the system including:
a volume image correlation module to obtain a displacement field between each image and the reference image, to obtain a plurality of displacement fields minimizing the difference between the volume images,
a processing module by a dimensionality reduction method of the plurality of the displacement fields to express them according to eigenmodes,
a statistical analysis module of the fields expressed according to the eigenmodes.

15. A computer program including instructions for the execution of the steps of a processing method according to claim 1, when said program is executed by a computer.
